(19) United States
(12) Patent Application Publication
(10) Pub. No.: US 2007/0038509 A1
(43) Pub. Date: Feb. 15, 2007

(54) Budget-based advertisement placement

(75) Inventors: Kamal Jain, Bellevue, WA (US); Kunal Talwar, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/200,633

(22) Filed: Aug. 10, 2005

(51) Int. Cl. G06Q 30/00

(52) U.S. Cl. 705/14

(57) ABSTRACT

Budget-based advertisement placement is described. Advertisements are selected for display via multiple available ad slots. Click-through prices are calculated for each of the advertisements such that if a particular advertisement is selected by a user, an advertiser is charged the click-through price for that advertisement. The advertisements are assigned to the available ad slots based, at least in part, on budget data associated with the advertisements.

### BACKGROUND

Many companies spend a lot of money each year on advertisements. In traditional advertising environments (e.g., newspaper, magazines, television, etc.), the price of an advertisement is typically based on visibility. For example, an ad that is placed on the front page of a newspaper is typically more expensive than an ad that is placed on the third page of the second section of the newspaper. Similarly, an advertiser will pay more to have an ad broadcast on television during primetime than he would pay to have the same ad broadcast on television at 2:00 am. With these traditional methods of advertising, the cost and placement of the advertisement is known up-front, and the advertisement slot provider (e.g., the newspaper company, magazine publisher, or television network) knows in advance the amount of revenue that will be generated by a particular advertisement slot.

Internet-based advertising differs somewhat in that advertisers are typically not charged for an ad being displayed, but are only charged if a user selects the ad, which typically directs the user to a website associated with the advertiser. This is commonly referred to as “click-through pricing”. Because advertisement visibility is still desired to attract a large number of users to the advertiser's website, high-visibility advertisement slots are desired. Advertisers typically bid auction-style for placement of ads within a web page, with the bid price indicating a maximum amount that the advertiser is willing to pay per click-through. For example, a search engine website may have five ad slots in a column down the right hand side of a web page on which search results are displayed. Advertisers may bid for those spots in conjunction with a particular keyword that a user may enter for a search. For example, a company that sells camera equipment may place a bid to have their advertisement displayed when a user submits a search using the keyword “camera”. When a user submits a search using the keyword “camera” , the ads from the advertisers who have submitted the five highest bids in association with the keyword “camera” are typically displayed in the five ad slots, with the ad from the highest bidding advertiser on top (i.e., in the most desirable of the five available ad slots).

Along with their bid, advertisers also submit a budget amount. After their budget is reached (based on the price paid per received click-through of the ad), the ad is no longer displayed. If two displayed advertisements have approximately the same click-through price, the advertisement with the highest associated budget has the potential to generate more revenue for ad slot provider.

### SUMMARY

Budget-based advertisement placement is described. Click-through prices are assigned to advertisements that are selected for display via a particular web page having multiple ad slots with varying desirability. The advertisements are assigned to the multiple ad slots based on budget data associated with each of the ads.

### BRIEF DESCRIPTION OF THE DRAWINGS

FIG. 1 is a pictorial diagram that illustrates an exemplary technique for budget-based advertisement placement.

FIG. 2 is a pictorial diagram that illustrates an exemplary technique for budget-based advertisement placement.

FIG. 3 is a block diagram that illustrates an exemplary network environment in which budget-based advertisement placement may be implemented.

FIG. 4 is a flow diagram that illustrates an exemplary method for budget-based advertisement placement.

### DETAILED DESCRIPTION

The embodiments of budget-based advertisement placement described below provide techniques for distributing advertisements among multiple ad slots on a single web page based on budget data associated with the advertisements. Multiple ad slots on a web page have varying degrees of desirability to an advertiser. For example, if arranged as a vertical list the ad slot on top is typically most desirable because it is usually the first ad a user will see. For this same reason, a more desirable (i.e., more visible) ad slot typically has the potential to generate greater revenue for the ad slot provider than a less desirable ad slot. Various types of budget data may be analyzed to determine how advertisements will be distributed among the available ad slots. Examples of budget data that may be analyzed include a residual budget, an initial budget, a spent budget value, a spent budget percentage, or an expected budget expenditure.

For example, a residual budget associated with an advertisement indicates a remaining amount that the advertiser is willing to pay for the advertisement to be displayed (and selected by users) during a particular time period. Advertisers typically pay a particular amount (a click-through price) each time a user clicks on an ad. Web page owners typically charge higher click-through prices for more desirable ad slots, and lower click-through prices for less desirable ad slots. However, it may be advantageous for a web page owner to place an advertisement with a higher residual budget in a more desirable ad slot, even if the advertisement is generating a lower click-through price. Because desirability of an ad slot is typically based on a likelihood that a user will select an ad displayed in that ad slot, ads placed in the most desirable ad slot are most likely to be selected by a user. By placing an advertisement with a high residual budget in the most desirable ad slot, the ad slot provider increases the chances of realizing the revenue represented by the residual budget associated with that advertisement.

The following discussion is directed to budget-based advertisement placement. While features of budget-based advertisement placement can be implemented in any number of different computing environments, they are described in the context of the following exemplary implementations.

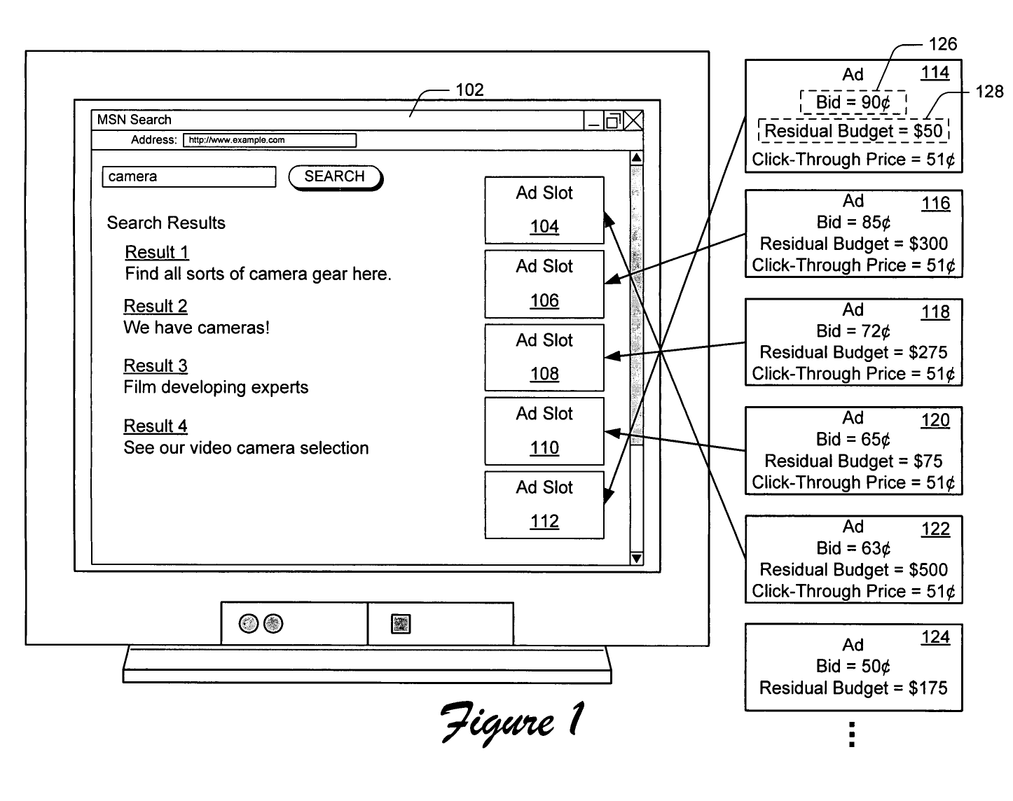

FIG. 1 illustrates an exemplary technique for assigning advertisements to available ad slots based on residual budgets associated with the advertisements. In an exemplary implementation, advertisers submit advertisements to an ad slot provider (e.g., a web page owner). The advertisements are then maintained by the ad slot provider such that the advertisements may be presented to a user via an ad slot at some future time. In addition to submitting an advertisement, an advertiser also submits a bid value and a budget value. The bid value indicates a maximum value that the advertiser is willing to pay if a user selects a particular ad (i.e., a click-through price). The budget value indicates a maximum value (calculated as a sum of charged click-through prices) that the advertiser is willing to pay for a particular advertisement over a fixed period of time (e.g., one day, one week, or one month). An advertisement is only available for display when a web page is requested if the specified budget associated with the advertisement has not yet been reached—that is, a residual budget remains for the particular advertisement.

In the illustrated example, web page 102 contains search results and five ad slots 104, 106, 108, 110, and 112. It is assumed that ad slot 104 is more desirable than ad slot 106, which is more desirable than ad slot 108, and so on. Advertisements are dynamically allocated to the available ad slots each time the web page is generated. When web page 102 is requested, five of the previously received advertisements are dynamically selected for display via the available ad slots. The advertisements to be displayed are typically selected based on the previously received bids associated with the advertisements. In the illustrated example, prior to displaying web page 102, advertisements 114, 116, 118, 120, 122, and 124 are identified as the previously received advertisements having the six highest bid values and sufficient residual budget values. Each of the identified advertisements has an associated bid and an associated residual budget. For example, advertisement 114 has associated bid 126 and associated residual budget value 128. In an exemplary implementation, the identified ads are sorted in descending order according to bid, as illustrated in FIG. 1. Ads 114, 116, 118, 120, and 122 have the five highest bid values, and so, are the five winning advertisements that will be assigned to the available ad slots. Ad 124 has the sixth highest bid, and so, is the first losing advertisement.

A click-through price is then calculated for each of the five winning advertisements. In this example, to calculate the click-through price for a particular advertisement, one cent is added to the bid associated with the first losing advertisement. For example, a click-through price of 51 cents is calculated by adding one cent to the bid associated with ad 124. This click-through price is then associated with each of the winning ads, 114-122, such that if the user viewing web page 102 clicks on any one of ads 114-122, the respective advertiser will be charged 51 cents.

After the winning advertisements are identified and click-through prices are assigned, the ads are assigned to the available ad slots based on the residual budgets. For example, as illustrated in FIG. 1, ad 122 is assigned to the first ad slot 104 because ad 122 has the highest residual budget of the five winning ads. Ads 116, 118, and 120 are assigned to ad slots 106, 108, and 110, respectively. Finally, ad 114, which has the highest bid value, but the lowest residual budget, is assigned to ad slot 112.

Although described with reference to a residual budget, it is recognized that any type of budget data may be used to determine advertisement placing across multiple available ad slots. Examples of budget data that may be analyzed include, but are not limited to, residual budget values, initial budget values, spent budget values, spent budget percentages, expected budget expenditures within a particular period of time, and so on.

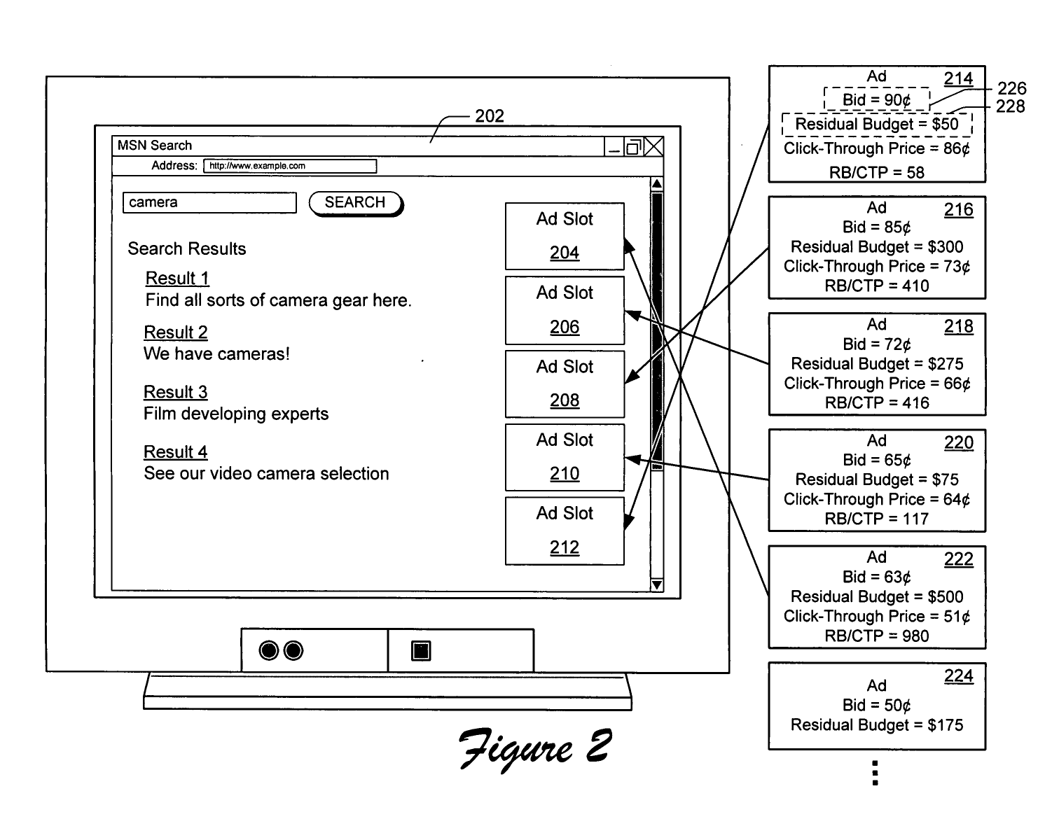

FIG. 2 illustrates an alternate technique for calculating click-through prices for advertisements, and for assigning those advertisements to ad slots based on residual budgets. It is recognized that any number of techniques may be used to calculate click-through prices, and the examples shown herein are not to be construed as limitations for implementing budget-based advertisement placement.

In the example illustrated in FIG. 2, web page 202 contains search results and five ad slots 204, 206, 208, 210, and 212. It is assumed that ad slot 204 is more desirable than ad slot 206, which is more desirable than ad slot 208, and so on. Advertisements are dynamically allocated to the available ad slots each time the web page is generated.

As described above, previously received ads have an associated bid that indicates a maximum value that the advertiser is willing to pay each time a user clicks on the ad. Prior to displaying web page 202, the previously received ads are sorted in descending order according to bid. Advertisements 214, 216, 218, 220, 222, and 224 are identified, as illustrated in FIG. 2, as the ads having the six highest bid values and a sufficient residual budget. Each of the identified advertisements also has an associated residual budget value. For example, advertisement 214 has associated bid value 226 and associated residual budget value 228. A click-through price is then calculated for each of the first five ads (i.e., the five winning ads). In this example, to calculate the click-through price for a particular ad, one cent is added to the bid associated with the next ad. For example, a click-through price of 86 cents is calculated for ad 214 by adding one cent to the bid associated with ad 216. Similarly, a click-through price of 73 cents is calculated for ad 216 by adding one cent to the bid associated with ad 218, and so on.

After the winning advertisements are identified and click-through prices are assigned, the ads are assigned to the available ad slots based, at least in part, on the residual budgets. In the illustrated example, the advertisements are assigned to the ad slots based on the following calculation:
Residual Budget/Click-Through price
The result of this calculation indicates a number of times that a particular advertisement may be selected by a user, given the current click-through price, before a total amount charged equals the residual budget.

For example, as illustrated in FIG. 2, advertisement 222 is assigned to the first ad slot 204 because the residual budget/click-through price for ad 222 is equal to 980, which is higher than the same calculated value for any of the other winning ads 214, 216, 218, and 220. Ads 216 and 218 are assigned to ad slots 108 and 106, respectively, even though ad 216 has a higher residual budget, because the residual budget/click-through price is greater for ad 218 than for ad 216. Advertisement 220 is assigned to ad slot 210, and finally, ad 214, which has the highest bid value, but the lowest residual budget/click-through price value of the winning ads, is assigned to ad slot 212.

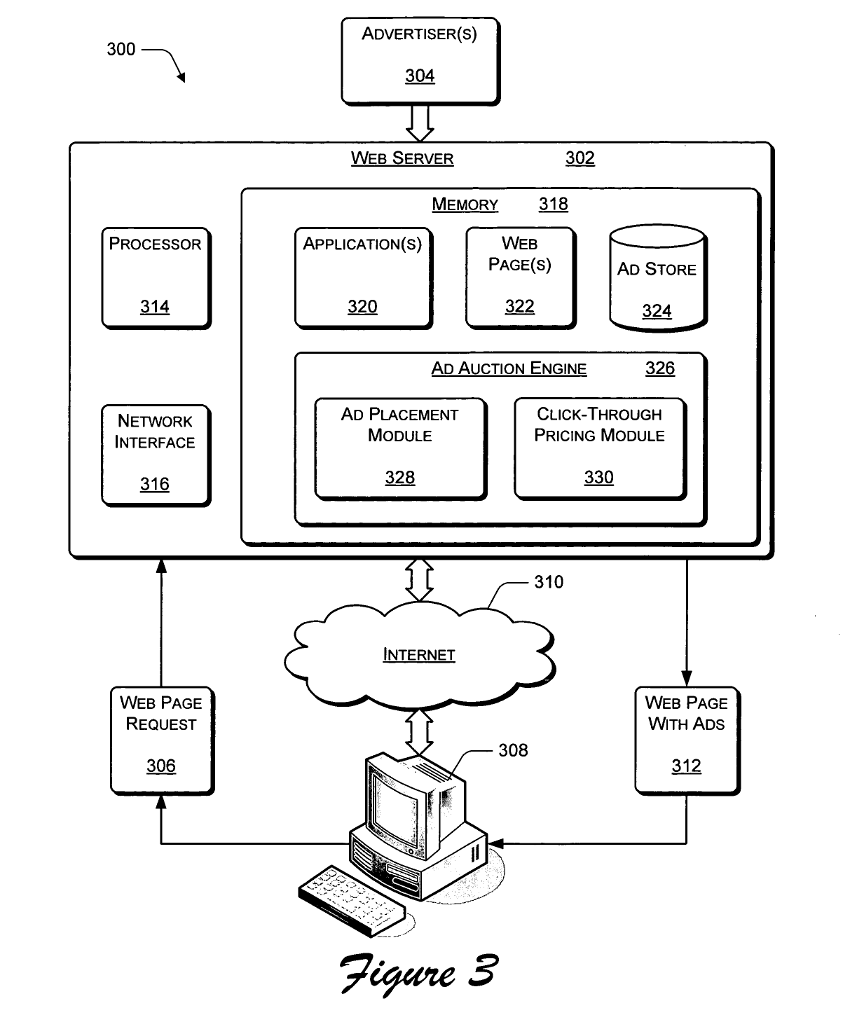

FIG. 3 illustrates an exemplary network environment 300 in which budget-based advertisement placement may be implemented. A web server 302 hosts one or more web pages that may display advertisements. One or more advertisers 304 submit advertisements to web server 302. The advertiser also submits a bid that indicates a maximum value that the advertiser is willing to pay each time the advertisement is selected by a user when displayed on a web page, and a budget that indicates a maximum value (calculated as a sum of charged click-through prices) that the advertiser is willing to pay for a particular advertisement during a particular period of time. A web page request 306 may be submitted via computer system 308 to web server 302 via a network such as the Internet 310. Web server 302 dynamically inserts advertisements into the web page, and returns the requested web page with ads 312.

Selected components of web server 302 may include a processor 314, a network interface 316, and memory 318. Network interface 316 enables web server 302 to receive data from advertiser(s) 304, and to communicate with computer system 308 over the Internet 310. One or more applications 320, one or more web pages 322, ad store 324, and ad auction engine 326 are maintained in memory 318 and executed on processor 314.

Web pages 322 each include one or more ad slots via which advertisements received from advertisers 304 may be presented. In the described exemplary implementation, ad slots on a web page may have varying degrees of desirability that may be based, for example, on visibility. For example, if a web page has one ad slot at the top of the page and another ad slot at the bottom of the page, the ad slot at the top of the page would be expected to have higher visibility, and therefore would be more desirable to advertisers. The ad slots associated with a web page may be ordered according to their respective desirability.

Ad store 324 maintains data associated with advertisements received from advertisers 304. Data that may be maintained may include, but is not limited to, an advertisement, a bid value, a budget value, and a residual budget value. As described above, the bid indicates a maximum value that the advertiser is willing to pay per click-through of the ad. The budget indicates a maximum value that the advertiser is willing to pay for placement of the ad over a particular period of time. For example, an advertiser may indicate a budget of $50 per day, or $1000 per month. The residual budget indicates a portion of the budget value that is currently remaining.

Ad auction engine 326 includes ad placement module 328 and click-through pricing module 330. Ad placement module 328 is configured to determine which ads in ad store 324 are to be presented via a particular web page 322. Ad placement module 328 also determines which of the identified ads are to be presented in each of the available ad slots, based, at least in part, on residual budgets associated with each of the ads. Click-through pricing module 330 is configured to determine for each ad placed in an ad slot, a click-through price that will be charged if a user selects the particular ad. As described above, any number of techniques may be used to determine click-through prices to be associated with the advertisements.

Methods for budget-based advertisement placement may be described in the general context of computer executable instructions. Generally, computer executable instructions include routines, programs, objects, components, data structures, procedures, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

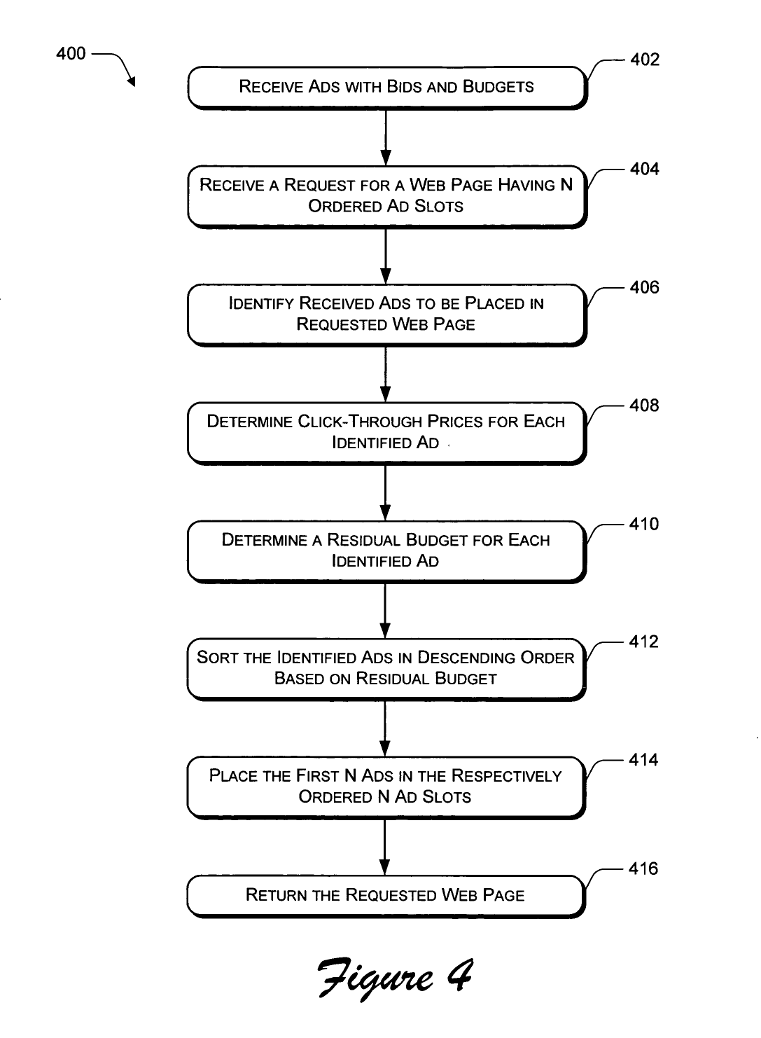

FIG. 4 illustrates an exemplary method 400 for budget-based advertisement placement. FIG. 4 is a specific example of budget-based advertisement placement, and is not to be construed as a limitation. Furthermore, it is recognized that various embodiments may implement any combination of portions of the method illustrated in FIG. 4. The order in which the method is described is not intended to be construed as a limitation, and any number of the described method blocks can be combined in any order to implement the method. Furthermore, the method can be implemented in any suitable hardware, software, firmware, or combination thereof.

At block 402, ads with associated bids and budgets are received. Each bid indicates a maximum click-through price that an advertiser is willing to pay each time the ad is selected by a user, and each budget indicates a total value that the advertiser is willing to pay, calculated as a sum of charged click-through prices, over a period of time. For example, web server 302 may receive one or more advertisements, bids, and budgets from advertiser(s) 304. The bids may also indicate one or more web pages in which the advertiser would like to have the ad placed.

At block 404, a request for a particular web page having N ordered ad slots is received. For example, web server 302 receives web page request 306 from computer system 308 via the Internet 310.

At block 406, one or more of the received ads are identified for placement in the requested web page. For example, ad auction engine 326 queries ad store 324 to identify the received ads that have the highest bid values and sufficient residual budget values. For example, the query may specify that for a particular ad to be returned, the residual budget value must be greater than the specified bid value for that ad. Furthermore, placement of a particular ad on a particular web page may be based, for example, on a keyword that was entered by a user as search criteria.

At block 408, click-through prices are determined for each of the identified ads. For example, click-through pricing module 330 may calculate a single click-through price to be applied to each of the identified ads, as illustrated and described above with reference to FIG. 1. Alternatively, click-through pricing module 330 may calculate different click-through prices to be applied to each of the identified ads, as illustrated and described above with reference to FIG. 2. Any number of techniques may be implemented for calculating the click-through prices, and the examples described herein are not intended as limitations.

At block 410 a residual budget is determined for each of the identified ads. For example, ad placement module 328 may query ad store 324 to determine, for each identified ad, a specified budget and how much of that specified budget has already been utilized. Those values are then used to calculate residual budgets for each of the identified ads.

At block 412, the identified ads are sorted in descending order based on the residual budget. In one implementation, the residual budget is used to sort the ads. In an alternative implementation, the residual budget is divided by the click-through price for the ad, and that value is used to sort the ads.

At block 414, the first N sorted ads are placed in the respectively ordered N ad slots on the web page. For example, ad placement module 328 places the ad with the highest residual budget in the most desirable ad slot, the ad with the second highest residual budget in the second most desirable ad slot, and so on.

At block 416, the requested web page is returned. For example, web server 302 transmits the web page with ads 312 to computer system 308 over the Internet 310.

Although embodiments of budget-based advertisement placement have been described in language specific to structural features and/or methods, it is to be understood that the subject of the appended claims is not necessarily limited to the specific features or methods described. Rather, the specific features and methods are disclosed as exemplary implementations of budget-based advertisement placement.

1. A computer-implemented method comprising:
identifying first and second ad slots, wherein the first ad slot is more desirable to an advertiser than the second ad slot;
identifying first and second advertisements to be assigned to the first and second ad slots;
determining first and second budget data respectively associated with the first and second advertisements; and
assigning the first and second advertisements to the first and second ad slots based on the first and second budget data.

2. The computer-implemented method as recited in claim 1, wherein the first budget data comprises at least one of a residual budget associated with the first advertisement, an initial budget associated with the first advertisement, a spent budget value associated with the first advertisement, a spent budget percentage associated with the first advertisement, or an expected budget expenditure associated with the first advertisement.

3. The computer-implemented method as recited in claim 1, wherein assigning the first and second advertisements to the first and second ad slots based on the first and second budget data comprises:
determining first and second residual budgets respectively associated with the first and second advertisements;
determining that the first residual budget is greater than the second residual budget;
assigning the first advertisement to the first ad slot; and
assigning the second advertisement to the second ad slot.

4. The computer-implemented method as recited in claim 1, wherein assigning the first and second advertisements to the first and second ad slots based on the first and second budget data comprises:
calculating a placement value for the first advertisement based on the first budget data;
calculating a placement value for the second advertisement based on the second budget data;
determining that the placement value for the first advertisement is greater than the placement value for the second advertisement;
assigning the first advertisement to the first ad slot; and
assigning the second advertisement to the second ad slot.

5. The computer-implemented method as recited in claim 4, wherein the first budget data comprises a first residual budget, the second residual budget comprises a second residual budget, and the first residual budget is less than the second residual budget.

6. The computer-implemented method as recited in claim 4, wherein the first budget data comprises a first residual budget, and wherein calculating a placement value for the first advertisement comprises dividing the first residual budget by a click-through price that indicates a value that will be charged to an advertiser when the first advertisement is selected by a user via the first or second ad slot.

7. The computer-implemented method as recited in claim 1, wherein identifying the first and second advertisements comprises:
receiving a plurality of advertisements, wherein each received advertisement has an associated bid value that indicates a maximum click-through price that an advertiser is willing to pay when a user selects a particular advertisement;
selecting the first advertisement from the plurality of advertisements wherein the first advertisement has a highest associated bid value; and
selecting the second advertisement from the plurality of advertisements wherein the second advertisement has a second-highest associated bid value.

8. The computer-implemented method as recited in claim 1, further comprising:
associating a first click-through price with the first advertisement; and
associating a second click-through price with the second advertisement.

9. The computer-implemented method as recited in claim 8, wherein the first click-through price is equal to the second click-through price.

10. The computer-implemented method as recited in claim 8, wherein the first click-through price is less than the second click-through price.

11. A system comprising:
a processor;
memory;
an ad auction engine maintained in the memory and executed on the processor, wherein the ad auction engine is configured to assign multiple advertisements to multiple ad slots on a web page based on budget data associated with the multiple advertisements.

12. The system as recited in claim 11, wherein the ad auction engine comprises an ad placement module configured to assign advertisements to ad slots in the web page, such that a first advertisement with a highest residual budget value is placed in a most desirable ad slot, and a second advertisement with a second highest residual budget value is place in a second most desirable ad slot.

13. The system as recited in claim 11, wherein the ad auction engine comprises an ad placement module configured to assign advertisements to ad slots in the web page by:
calculating placement values associated with the advertisements; and
assigning the advertisements to the ad slots such that the advertisement with the highest placement value is assigned to the most desirable ad slot.

14. The system as recited in claim 13, wherein the ad placement module calculates a placement value for a particular advertisement by dividing a residual budget associated with the particular advertisement by a click-through price associated with the particular advertisement.

15. The system as recited in claim 13, wherein the ad placement module calculates a placement value for a particular advertisement based on at least one of a residual budget associated with the particular advertisement, an initial budget associated with the particular advertisement, a spent budget value associated with the particular advertisement, a spent budget percentage associated with the particular advertisement, or an expected budget expenditure associated with the particular advertisement.

16. The system as recited in claim 11, wherein the ad auction engine comprises a click-through pricing module configured to calculate first and second click-through prices to be charged, respectively, if a user selects the first or second advertisement.

17. One or more computer-readable media comprising computer-readable instructions which, when executed, cause a computer system to:
receive a request for a web page, the web page having first and second ad slots, wherein the first ad slot is more desirable than the second ad slot;
identify first and second advertisements to be displayed via the first and second ad slots, wherein each of the advertisements has associated budget data;
assign the first and second advertisements to the first and second ad slots based on the budget data associated with the advertisements; and
return the requested web page.

18. The one or more computer-readable media as recited in claim 17, further comprising computer-readable instructions which, when executed, cause the computer system to assign the first and second advertisements to the first and second ad slots based on the budget data associated with the advertisements by:
determining that a residual budget associated with the first advertisement is greater than a residual budget associated with the second advertisement;
assigning the first advertisement to the first ad slot; and
assigning the second advertisement to the second ad slot.

19. The one or more computer-readable media as recited in claim 17, further comprising computer-readable instructions which, when executed, cause the computer system to assign the first and second advertisements to the first and second ad slots based on the budget data associated with the advertisements by:
calculating a possible number of click-throughs associated with the first advertisement by dividing a residual budget associated with the first advertisement by a click-through price associated with the first advertisement;
calculating a possible number of click-throughs associated with the second advertisement by dividing a residual budget associated with the second advertisement by a click-through price associated with the second advertisement;
determining that the possible number of click-throughs associated with the first advertisement is greater than the possible number of click-throughs associated with the second advertisement;
assigning the first advertisement to the first ad slot; and
assigning the second advertisement to the second ad slot.

20. The one or more computer-readable media as recited in claim 17, further comprising computer-readable instructions which, when executed, cause the computer system to assign the first and second advertisements to the first and second ad slots based on the budget data associated with the advertisements by:
calculating a placement value associated with the first advertisement based on the budget data associated with the first advertisement;
calculating a placement value associated with the second advertisement based on the budget data associated with the second advertisement;
determining that the placement value associated with the first advertisement is greater than the placement value associated with the second advertisement;
assigning the first advertisement to the first ad slot; and
assigning the second advertisement to the second ad slot.
